(19) United States
(12) Patent Application Publication
(10) Pub. No.: US 2022/0030769 A1
(43) Pub. Date: Feb. 3, 2022

(54) SOFTWARE CONTROLLED PLANT TRIMMER

(71) Applicant: 2GC Holdings, LLC, St. Louis, MO (US)

(72) Inventors: Alexander KRICHEVSKY, St. Louis, MO (US); Daniel SAUNDERS, Melbourne (AU)

(21) Appl. No.: 17/385,490

(22) Filed: Jul. 26, 2021

Related U.S. Application Data
(60) Provisional application No. 63/058,321, filed on Jul. 29, 2020.

(51) Int. Cl. A01D 46/30; G06T 7/00; G06K 9/00; A01D 45/00

(52) U.S. Cl. CPC A01D 46/30; G06T 7/0004; G06T 2207/30108; A01D 45/00; G06K 9/00657

(57) ABSTRACT

Methods, storage media and systems for trimming objects are disclosed. Some embodiments may include: generating a computerized image of an object to be trimmed, designating a part of the object to trim off, generating at least one output command to guide a trimming hardware and trimming the designated part of the object.

### CROSS-REFERENCE

This application claims the benefit of priority of U.S. Provisional Patent Application Ser. No. 63/058,321 filed Jul. 29, 2020, the disclosure of which is incorporated by reference in its entirety for all purposes.

### FIELD

This disclosure relates to a software-controlled plant trimming apparatus and the method of operation of software-controlled trimming.

### BACKGROUND

Mechanized trimmers are widely used to trim excess plant parts, such as stems, leaves, petals, and other tissues, from various crops. Trimmers are used, for example, on hops, rosemary, oregano, basil, mint, lavender, coriander, parsley, mixed flowers, and other plant types. Particularly, plant trimmers are very useful in trimming cannabis buds and flowers, pre- or post-drying, removing excess and undesired plant material, and ensuring proper esthetical presentation.

Often crops are collected during a short harvest season, resulting in a large amount of material that needs to be processed and trimmed in a short period, creating shortages in machinery and human labor. Moreover, some plant material cannot be completely trimmed using mechanical trimmers, often requiring a human trimmer to finish the final product. This significantly increases production costs and decreases the speed of product output.

The present disclosure provides a software-controlled plant trimmer capable of trimming and processing plant materials faster and with higher dexterity than human trimmers. These systems and methods extensively save costs and generate higher quality products. In addition, software-controlled plant trimmers reduce human handling of the product, thus reducing the rate of pathogen transmission.

### SUMMARY

The following embodiments and aspects thereof are described and illustrated in conjunction with methods, media, and systems, which are meant to be exemplary and illustrative, not limiting in scope. In various embodiments, one or more of the above-described problems have been reduced or eliminated, while other embodiments are directed to other improvements.

One aspect of the present disclosure relates to a method for trimming objects. The method may include generating a computerized image of an object to be trimmed. The method may include designating a part of the object to trim off. The method may include generating at least one output command to guide trimming hardware. The method may include trimming the designated part of the object.

Another aspect of the present disclosure relates to a computer-readable storage medium for trimming objects. In some embodiments, the computer-readable storage medium may include instructions being executable by one or more processors to generate a computerized image of an object to be trimmed. In some embodiments, the computer-readable storage medium may include instructions being executable by one or more processors to designate a part of the object to trim off. In some embodiments, the computer-readable storage medium may include instructions being executable by one or more processors to generate at least one output command to guide trimming hardware. In some embodiments, the computer-readable storage medium may include instructions being executable by one or more processors to trim the designated part of the object.

Another aspect of the present disclosure relates to a system for trimming objects. The system may include one or more hardware processors configured by machine-readable instructions for trimming objects. The machine-readable instructions may be configured to generate a computerized image of an object to be trimmed. The machine-readable instructions may be configured to designate a part of the object to trim off. The machine-readable instructions may be configured to generate at least one output command to guide trimming hardware. The machine-readable instructions may be configured to trim the designated part of the object.

Additional embodiments and features are set forth in part in the description that follows. In part will become apparent to those skilled in the art upon examination of the specification or learned by the practice of the embodiments discussed herein. A further understanding of the nature and advantages of certain embodiments may be realized by reference to the remaining portions of the specification and the drawings, which form a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects and do not limit the scope of the disclosure.

FIG. 1 shows a software-controlled trimmer apparatus.

FIG. 2 illustrates another system according to the present disclosure configured for trimming objects.

FIG. 3 illustrates a method for trimming objects.

FIG. 4 is a block diagram illustrating an example of a suitable computing system environment in which aspects of the present disclosure may be implemented.

### DETAILED DESCRIPTION

The present disclosure provides an apparatus, a machine, a device, and a method for software-controlled plant trimming, comprising an imaging device operably linked to a processor encompassing image processing software capable of evaluating and discriminating, and optionally quantifying, various aspects of the object, including it being a plant or a plant part. The resulting image is analyzed using image analyzing software, which may or may not comprise an artificial intelligence component, to designate object parts that need to be removed. Then one or more output commands are created to control and direct a trimming tool that removes the designated parts.

“Artificial intelligence,” or “AI,” refers to intelligence demonstrated by machines lacking consciousness and emotionality. “Strong” AI is usually labeled as artificial general intelligence (AGI), while attempts to emulate “natural” intelligence have been called artificial biological intelligence (ABI). An “intelligent agent” is any device or software that perceives its environment and takes actions that maximize its chance of achieving its goals. Generally, “artificial intelligence” often describes machines that mimic “cognitive” functions that humans associate with the human mind, such as “learning” and “problem-solving.”

In one aspect, at least a portion of a plant or a plant part is imaged, followed by analyzing the image for identification and designation of unwanted parts, such as protruding leaves, stems, petals, or any other plant tissues. A variety of cameras can be used for the imaging process, with non-limiting examples including a standard camera, an HD camera, a video camera, a charge-coupled device (CCD) camera, and other types of cameras. In another aspect, the image being analyzed and said analysis produce commands that control and guide a trimming tool, removing unwanted parts. A non-limiting example of an output command is a command based on the G-code, which is well known in the art to guide computerized machine tools. Tool operations are defined by G-code instructions provided to a machine controller, which is operably linked to a motor, guiding the tool to move, how fast to move, and what path to follow. Examples of computer-controlled tools and hardware for trimming the designated parts, include but are not limited to, scissors, blades, clippers, etc. In addition, one or more tools can be used in the trimming process, wherein said tools might be selected from a digital tool library.

In one embodiment, the plant or plant part is positioned stationary within the trimmer, and the trimming tool is mobile. In another embodiment, the tool might be stationary and the plant or plant part mobile. In yet another embodiment, either the tool or the plant part, or both, are mobile. Similarly, the imaging equipment can be either stationary or mobile, depending on the best fit configuration for a particular purpose. In all embodiments mentioned above, objects and tools may move around a variety of axes, such a movement around five axes.

In another embodiment of the disclosure, the imaging is performed at ambient lighting. In yet another embodiment, the imaging process is enhanced by illuminating all or a portion of the trimmed object with a beam of light or other energy. The illumination can optionally be selected to provide enhanced contrast between the targeted aspect or subject matter to be discriminated and the remainder of the trimmed object. Such enhanced contrast techniques may include light emission/absorption based on fluorescence or pigment composition of the target tissue.

Optionally, the software-controlled trimmer can be operationally linked to a standard mechanical trimmer to remove excess material prior- or post-software-controlled trimming. In addition, the trimmer can be operationally connected to a bucking machine (also known as destemmer or debudder).

The software-controlled trimmer can be used to trim either wet or dry plant material, i.e., before or after the drying process of the plant material occurs. In one embodiment, the plant material is dried before trimming to reduce potential clogging. The trimmer may trim one or more objects, including plants or plant parts, at a time. Once trimming of plant or a plant part is completed, it is removed from the trimmer, and the next plant or plant part is delivered for trimming. This apparatus and method might be useful for trimming not only plants but also other objects.

### Imaging

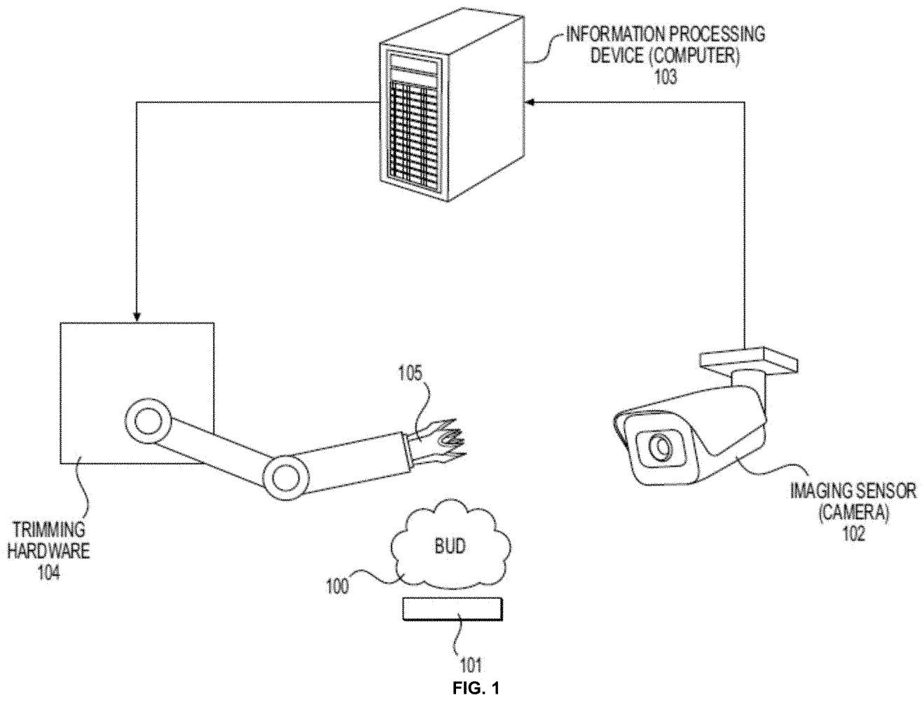

As the first step, referring to FIG. 1, the present disclosure provides a computerized imaging system for creating a 3D or other type of suitable image of an object (i.e., plant or a plant part) 100. The imaging system comprises a stage 101 or another hardware solution to present, hold, or maintain the object, and an imaging sensor 102 allows capturing the object's images. An example of an imaging sensor is a camera. In one embodiment, the computerized imaging system may include an object stage mounted on a system base plate where the object stage is configured to rotate 360 degrees around its axis perpendicular to the base plate plane. Alternatively, the imaging sensor may be mobile and move around the object and the plate or other hardware it's positioned on while the object stays stationary. The imaging sensor captures one or more images of the object positioned on the object stage. In certain embodiments, a plurality of images in a plurality of rotation and elevation angles are used. Images further can be stored or processed on an information processing device 103, such as a computer, operationally linked to said imaging sensor. Therefore, one or more information processing devices, such as computers, can be used in the present disclosure.

According to a further embodiment, a computerized method for creating appropriate imaging of an object is provided. While a variety of imaging technologies and software applications might be used to create the type of imaging suitable for the present disclosure, 3D imaging is a non-limiting example of such appropriate technology. The computerized method includes providing a computerized imaging system, uploading a pattern of system configuration parameters stored in a storage medium according to the object type, and continuously aligning the object center of mass with the object stage shaft axis. In addition, the computerized method includes capturing a plurality of images with pre-defined points of view of the object, culminating in a 3D image of the object.

### Image Analysis and Output Commands

The apparatus comprises at least one information processing device 103, such as a computer, with one or more software applications or components, or algorithms, to evaluate the measured object. Types of software or algorithms for such evaluations and analysis are well known in the art. The processing device will conduct image analysis and designate those unwanted parts of an object, namely plant or plant parts, which need to be removed and trimmed off. An example of cannabis flower or buds, such as undesirable parts, may be sugar leaves or fan leaves protruding from the bud.

Image analysis by the information processing device 103 results in creating output commands to remove the unwanted parts. A non-limiting example of such a set of commands can be produced using G-code and loaded into the machine tool controller. Moreover, certain types of programs, well known in the art, can automatically generate machine-cutting instructions from nominal dimensions of an object represented in software.

The information processing device can be employed locally, via cloud service, or by other means known in the art. In addition, the software or algorithms employed with the information processing device may optionally include artificial intelligence components.

### Trimming

The information processing device 103 is further operationally linked to a mechanical trimming device or trimming hardware 104. A non-limiting example of a trimming device is a robotic arm comprising a cutting tool 105 to remove object parts designated by the software. Following a set of output commands from the information processing device, for instance, in G-code, the robotic arm targets parts designated for removal and cut them off using a cutting tool. Non-limiting examples of cutting tools include scissors, blades, tweezers, and other mechanical means.

One or more trimming devices or trimming hardware pieces, such as robotic arms, can trim the object. The trimming process continues until all unwanted parts designated by the software are removed. Thus, one or more cycles of output commands may be needed to complete the trimming process. Once the trimming is finished, the object is removed from the trimming apparatus, and a new object for trimming is fed in.

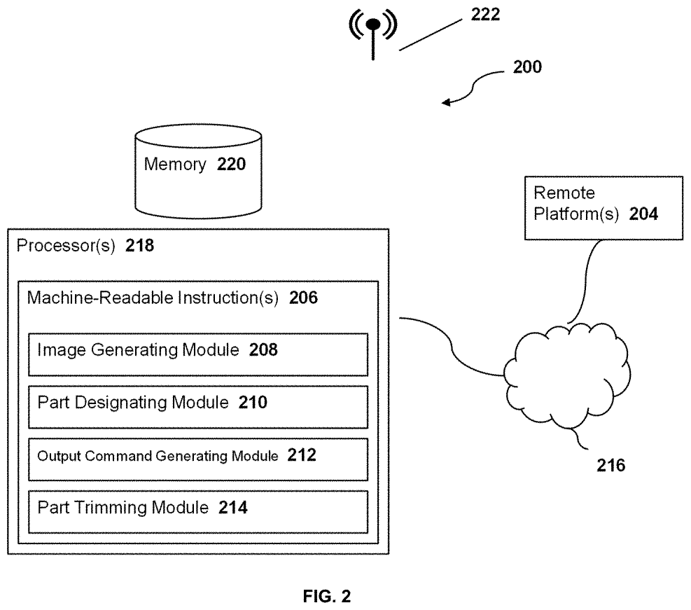

FIG. 2 illustrates another system disclosure configured for trimming objects per one or more embodiments. In some cases, system 200 may include one or more computing platforms 202. The one or more remote computing platforms 202 may be communicably coupled with one or more remote platforms 204. In some cases, users may access the system 200 via the remote platform(s) 204.

The one or more computing platforms 202 may be configured by machine-readable instructions 206. Machine-readable instructions 206 may include modules. The modules may be implemented as one or more of functional logic, hardware logic, electronic circuitry, software modules, and the like. For example, the modules may include one or more of image generating module 208, part designating module 210, output command generating module 212, part trimming module 214, and/or other modules.

Image generating module 208 may be configured to generate a computerized image of an object to be trimmed. Part designating module 210 may be configured to designate a part of the object to trim off. Output command generating module 212 may be configured to generate at least one output command to guide trimming hardware. Part trimming module 214 may be configured to trim the designated part of the object.

In some cases, the one or more computing platforms 202 may be communicatively coupled to the remote platform(s) 204. In some cases, the communicative coupling may include communicative coupling through a networked environment 216. The networked environment 216 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 202 and remote platform(s) 204 may be operatively linked via some other communication coupling. For example, the one or more one or more computing platforms 202 may be configured to communicate with the networked environment 216 via wireless or wired connections. In addition, in an embodiment, the one or more computing platforms 202 may be configured to communicate directly with each other via wireless or wired connections. Examples of one or more computing platforms 202 may include, but is not limited to, smartphones, wearable devices, tablets, laptop computers, desktop computers, Internet of Things (IoT) device, or other mobile or stationary devices. In an embodiment, system 200 may also include one or more hosts or servers, such as the one or more remote platforms 204 connected to the networked environment 216 through wireless or wired connections. According to one embodiment, remote platforms 204 may be implemented in or function as base stations (which may also be referred to as Node Bs or evolved Node Bs (eNBs)). In other embodiments, remote platforms 204 may include web servers, mail servers, application servers, etc. According to certain embodiments, remote platforms 204 may be standalone servers, networked servers, or an array of servers.

The one or more computing platforms 202 may include one or more processors 218 for processing information and executing instructions or operations. One or more processors 218 may be any general or specific purpose processor. In some cases, multiple processors 218 may be used according to other embodiments. The one or more processors 218 may include one or more general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 218 may be remote from the one or more computing platforms 202, such as disposed within a remote platform like the one or more remote platforms 218 of FIG. 2.

The one or more processors 218 may perform functions for the operation of system 100, which may include, for example, precoding of antenna gain/phase parameters, encoding, and decoding of individual bits forming a communication message, formatting of information, and overall control of the one or more computing platforms 202, including processes related to managing communication resources.

The one or more computing platforms 202 may further include or be coupled to a memory 220 (internal or external), which may be coupled to one or more processors 218, for storing information and instructions that may be executed by one or more processors 218. Memory 220 may be one or more memories and of any type suitable to the local application environment and may be implemented using any suitable volatile or nonvolatile data storage technology such as a semiconductor-based memory device, a magnetic memory device and system, an optical memory device, and system, fixed memory, and removable memory. For example, memory 220 can consist of any combination of random access memory (RAM), read-only memory (ROM), static storage such as a magnetic or optical disk, hard disk drive (HDD), or any other type of non-transitory machine or computer-readable media. In addition, the instructions stored in memory 220 may include program instructions or computer program code that, when executed by one or more processors 218, enable the one or more computing platforms 202 to perform tasks as described herein.

In some embodiments, one or more computing platforms 202 may also include or be coupled to one or more antennas for transmitting and receiving signals and/or data to and from one or more computing platforms 202. The one or more antennas may be configured to communicate via, for example, a plurality of radio interfaces that may be coupled to the one or more antennas. The radio interfaces may correspond to a plurality of radio access technologies, including one or more of LTE, 5G, WLAN, Bluetooth, near field communication (NFC), radiofrequency identifier (RFID), ultrawideband (UWB), and the like. In addition, the radio interface may include components, such as filters, converters (for example, digital-to-analog converters and the like), mappers, a Fast Fourier Transform (FFT) module, and the like, to generate symbols for transmission via one or more downlinks and to receive symbols (for example, via an uplink).

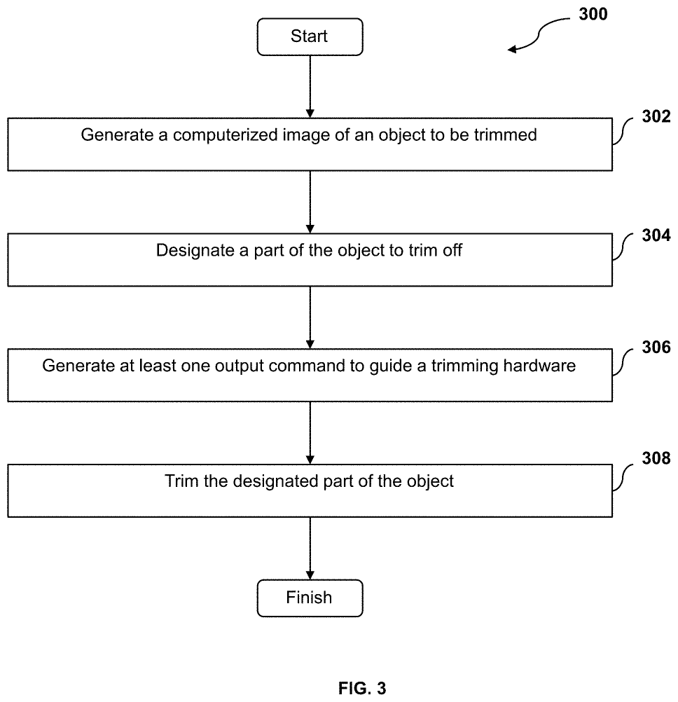

FIG. 3 illustrate an example flow diagram of a method 300, according to one embodiment. The method 300 may include generating a computerized image of an object to be trimmed at block 302. The method 300 may include designating a part of the object to trim off at block 304. The method 300 may include generating at least one output command to guide trimming hardware at block 306. The method 300 may include trimming the designated part of the object at block 308.

In some cases, the method 300 may be performed by one or more hardware processors, such as the processors of FIG. 1, configured by machine-readable instructions, such as the machine-readable instructions of FIG. 1. In this aspect, the method 300 may be configured to be implemented by the modules in FIG. 2.

In some cases, the method 300 may be performed by one or more hardware processors, such as the processors 218 of FIG. 2, configured by machine-readable instructions, such as the machine-readable instructions 206 of FIG. 2. In this aspect, the method 300 may be configured to be implemented by the modules, such as the modules 208, 210, 212, and/or 214 discussed above in FIG. 2

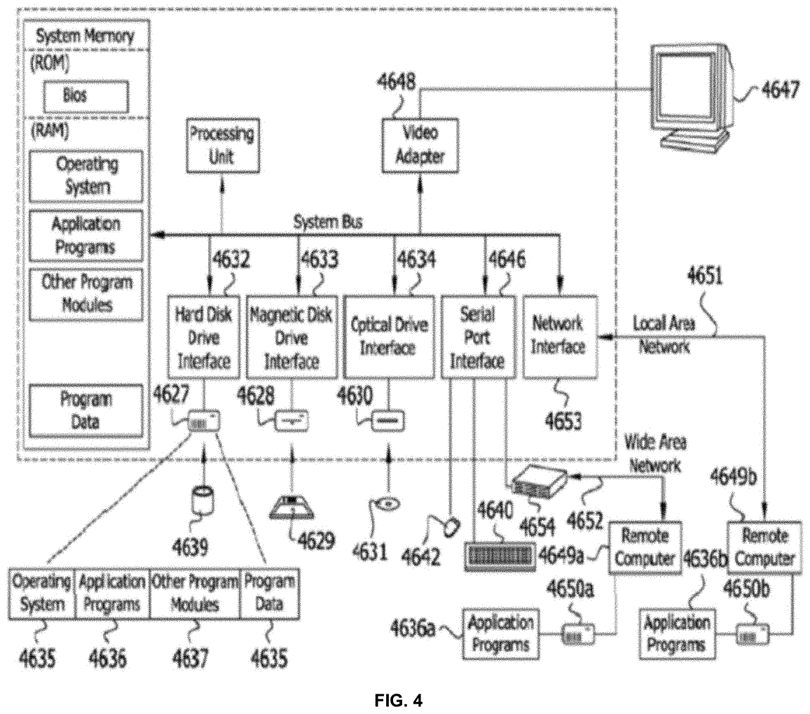

Concerning FIG. 4, an exemplary system for implementing aspects includes a general-purpose computing device in the form of a conventional computer 4620, including a processing unit 4621, a system memory 4622, and a system bus 4623 that couples various system components, including the system memory 4622 to the processing unit 4621. The system bus 4623 may be any of several bus structures, including a memory bus or memory controller, a peripheral bus, and a local bus using various bus architectures. The system memory includes read-only memory (ROM) 4624 and random-access memory (RAM) 4625. In addition, a basic input/output system (BIOS) 4626, containing the basic routines that help transfer information between elements within the computer 4620, such as during start-up, may be stored in ROM 4624.

The computer 4620 may also include a magnetic hard disk drive 4627 for reading from and writing to a magnetic hard disk 4639, a magnetic disk drive 4628 for reading from or writing to a removable magnetic disk 4629, and an optical disk drive 4630 for reading from or writing to removable optical disk 4631, such as a CD-ROM or other optical media. The magnetic hard disk drive 4627, magnetic disk drive 4628, an optical disk drive 4630 are connected to the system bus 4623 by a hard disk drive interface 4632, a magnetic disk drive-interface 4633, and an optical drive interface 4634, respectively. The drives and their associated computer-readable media provide nonvolatile storage of computer-executable instructions, data structures, program modules, and other data for the computer 4620. Although the exemplary environment described herein employs a magnetic hard disk 4639, a removable magnetic disk 4629, and a removable optical disk 4631, other types of computer-readable media for storing data can be used, including magnetic cassettes, flash memory cards, digital video disks, Bernoulli cartridges, RAMs, ROMs, and the like.

Program code means comprising one or more program modules may be stored on the hard disk 4639, magnetic disk 4629, optical disk 4631, ROM 4624, and/or RAM 4625, including an operating system 4635, one or more application programs 4636, other program modules 4637, and program data 4638. A user may enter commands and information into the computer 4620 through keyboard 4640, pointing device 4642, or other input devices (not shown), such as a microphone, joystick, gamepad, satellite dish, scanner, or the like. These and other input devices are often connected to the processing unit 4621 through a serial port interface 4646 coupled to the system bus 4623. Alternatively, the input devices may be connected by other interfaces, such as a parallel port, a game port, or a universal serial bus (USB). A monitor 4647 or another display device is also connected to system bus 4623 via an interface, such as video adapter 4648. In addition to the monitor, personal computers typically include other peripheral output devices (not shown), such as speakers and printers.

The computer 4620 may operate in a networked environment using logical connections to one or more remote computers, such as remote computers 4649a and 4649b. Remote computers 4649a and 4649b may each be another personal computer, a server, a router, a network PC, a peer device, or another common network node. These typically include many or all the elements described above relative to the computer 4620. However, only memory storage devices 4650a and 4650b and their associated application programs 4636a and 4636b have been illustrated in FIG. 5. The logical connections depicted in FIG. 5 include a local area network (LAN) 4651 and a wide area network (WAN) 4652 presented here by way of example and not limitation. Such networking environments are commonplace in office-wide or enterprise-wide computer networks, intranets, and the Internet.

When used in a LAN networking environment, the computer 4620 is connected to the local network 4651 through a network interface or adapter 4653. When used in a WAN networking environment, the computer 4620 may include a modem 4654, a wireless link, or other means for establishing communications over the wide area network 4652, such as the Internet. The modem 4654, internal or external, is connected to the system bus 4623 via the serial port interface 4646. In a networked environment, program modules depicted relative to the computer 4620 or portions thereof may be stored in the remote memory storage device. It will be appreciated that the network connections shown are exemplary and other means of establishing communications over wide area network 4652 may be used.

One or more aspects may be embodied in computer-executable instructions (i.e., software), such as a software object, routine, or function (collectively referred to herein as a software) stored in system memory 4624 or nonvolatile memory 4635 as application programs 4636, program modules 4637, and/or program data 4638. The software may be stored remotely, such as on remote computers 4649a and 4649b with remote application programs 4636b. Generally, program modules include routines, programs, objects, components, data structures, etc., that perform particular tasks or implement particular abstract data types when executed by a processor in a computer or other device. The computer-executable instructions may be stored on a computer-readable medium such as a hard disk 4627, optical disk 4630, solid-state memory, RAM 4625, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like.

A programming interface (or, more simply, interface) may be viewed as any mechanism, process, or protocol for enabling one or more segment(s) of code to communicate with or access the functionality provided by one or more other segment (s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of another component (s). The term “segment of code” in the preceding sentence is intended to include one or more instructions or lines of code. Thus, it includes, e.g., code modules, objects, subroutines, functions, and so on, regardless of the terminology applied or whether the code segments are separately compiled, or whether the code segments are provided as a source, intermediate, or object code, whether the code segments are used in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium is wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment accesses functionality performed by a second code segment. Any or all these aspects may be important in a given situation, e.g., depending on whether the code segments are part of a system in a loosely coupled or tightly coupled configuration. So this list should be considered illustrative and non-limiting.

This notion of a programming interface is known to those skilled in the art and is clear from the detailed description. Some illustrative implementations of a programming interface may also include factoring, redefinition, inline coding, divorce, rewriting, to name a few. There are, however, other ways to implement a programming interface, and, unless expressly excluded, these, too, are intended to be encompassed by the claims set forth at the end of this specification.

Embodiments within the scope of the present disclosure also include computer-readable media and computer-readable storage media for carrying or having computer-executable instructions or data structures stored thereon. Such computer-readable media can be any available media that a general-purpose or special-purpose computer can access. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general-purpose or special-purpose computer. When information is transferred or provided over a network or another communications connection (either hardwired, wireless, or a combination of hardwired or wireless), the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

### EP Support Example

Example 1 includes a method comprising: generating a computerized image of an object to be trimmed, designating a part of the object to trim off, generating at least one output command to guide trimming hardware, and trimming the designated part of the object.

Example 2 includes a storage medium comprising: generating a computerized image of an object to be trimmed, designating a part of the object to trim off, generating at least one output command to guide trimming hardware, and trimming the designated part the object.

Example 3 includes a system comprising: generating a computerized image of an object to be trimmed, designating a part of the object to trim off, generating at least one output command to guide trimming hardware, and trimming the designated part of the object.

What we claim is:

1. A computerized method for trimming objects, the method comprising the steps of:
generating a computerized image of an object to be trimmed;
designating a part of the object to trim off;
generating at least one output command to guide a trimming hardware; and
trimming the designated part of the object.

2. The method of claim 1, wherein the object is a plant.

3. The method of claim 2, wherein the plant part is a cannabis bud or flower.

4. A non-transient computer-readable storage medium comprising instructions being executable by one or more processors to perform a method, the method comprising:
generating a computerized image of an object to be trimmed;
designating a part of the object to trim off;
generating at least one output command to guide a trimming hardware; and
trimming the designated part of the object.

5. The medium of claim 4, wherein the object is a plant.

6. The medium of claim 5, wherein the plant part is a cannabis bud or flower.

7. A system for trimming an object, comprising:
one or more hardware processors configured by machine-readable instructions to:
generate a computerized image of an object to be trimmed;
designate a part of the object to trim off;
generate at least one output command to guide a trimming hardware; and
trim the designated part of the object.

8. The system of claim 7, wherein the object is a plant.

9. The system of claim 8, wherein the plant part is a cannabis bud or flower.

10. The system of claim 7, further comprising a mechanical (non-software-controlled) trimmer.

11. The system of claim 7, further comprising a debudder or a bucking device.

12. The system of claim 7, further comprising a packaging device.
